(19) United States
(12) Patent Application Publication
(10) Pub. No.: US 2026/0306936 A1
(43) Pub. Date: Oct. 8, 2026

(54) ICE PROTECTION PANEL SYSTEM

(71) Applicant: Signature Systems Group, LLC, Flower Mound, TX (US)

(72) Inventors: Andrew SEVERANCE, Decatur, TX (US); James SEEGER, Oak Point, TX (US); Hamzeh FATHOLLAHZADEH, Orlando, FL (US); Kamal FOUAD, Kissimmee, FL (US); Asa Charles HARRIS, Lewisville, TX (US); Charles KOLIAS, McKinney, TX (US)

(21) Appl. No.: 19/170,395

(22) Filed: Apr. 4, 2025

(51) Int. Cl. A63C 19/12; B32B 3/06; B32B 3/12; B32B 5/20; B32B 27/06; B32B 27/32

(52) U.S. Cl. CPC A63C 19/12; B32B 3/06; B32B 3/12; B32B 5/20; B32B 27/065; B32B 27/32; B32B 2250/40; B32B 2266/0278; B32B 2607/00

(57) ABSTRACT

A panel for protecting an ice surface includes a lower shell, an upper shell, and an insulation material arranged within an interior space defined by the lower shell and the upper shell when assembled together. The panel includes complementary locking structures on opposite sides of the panel, and the panel further includes corresponding alignment structures for facilitate alignment of the upper and lower shell. The lower shell includes a lower alignment structure and the upper shell includes an upper alignment structure that each extend within the interior space and are complementary with each other.

### FIELD OF THE DISCLOSURE

The present disclosure relates generally to protective covers or panels and, more particularly, to covers or panels for protecting ice in an ice rink.

### BACKGROUND OF THE DISCLOSURE

Multiple situations exist where the ice in ice rinks needs to be protected. For example, during the half time show of a hockey game, an event may be held on the ice. Events may include concerts or other types of entertainment that may occur during a pause in the action. In these situations, covers will be placed over the ice to form a safe surface on which the event may occur without slipping on the ice. Not only do such covers provide a safe means to walk, but they may also prevent damage from occurring to the ice, for example, by equipment that may be placed over the ice that would necessitate delaying resumption of the game until the ice is repaired, such as resurfacing the damaged ice with a Zamboni or other ice repair tool. Existing covers, however, do not adequately insulate the ice which can cause melting that delays gameplay or seeps up through the cover to create a wet walking surface. Furthermore, existing covers do not allow for a full covering of the ice rink and also do not adequately protect the ice from other accidents that may occur on top of the cover, such as spills.

Accordingly, improved methods and systems are desired for insulating and protecting the ice in ice rinks.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a panel for protecting an ice surface comprises a lower shell and an upper shell. The lower shell comprises a lower wall and a lower peripheral sidewall extending upward from the lower wall, the lower wall and the lower peripheral sidewall together defining a lower interior cavity. The upper shell comprises an upper wall and an upper peripheral sidewall extending downward from the upper wall. The upper wall and the upper peripheral sidewall together defining an upper interior cavity. When the lower shell and the upper shell are assembled together, the lower peripheral sidewall and the upper peripheral sidewall together define a perimeter sidewall of the panel that extends between the lower wall and the upper wall, and the upper and lower interior cavities are in communication with each other such that they together form an interior space of the panel, with the interior space being defined within the lower wall, the upper wall, and the perimeter sidewall. The panel further includes complementary locking structures on opposite sides of the perimeter sidewall. The panel further includes a lower alignment structure extending upward from the lower wall and an upper alignment structure extending downward from the upper wall, the upper and lower alignment structures being complementary with each other to facilitate alignment of the upper and lower shells. The panel further includes an insulation material arranged in the interior space.

According to an embodiment consistent with the present disclosure, a method of forming a panel includes forming a lower shell and an upper shell of the panel. The lower shell comprises a lower wall and a lower peripheral sidewall extending upward from the lower wall, the lower wall and the lower peripheral sidewall together defining a lower interior cavity. The upper shell comprises an upper wall and an upper peripheral sidewall extending downward from the upper wall. The upper wall and the upper peripheral sidewall together defining an upper interior cavity. When the lower shell and the upper shell are assembled together, the lower peripheral sidewall and the upper peripheral sidewall together define a perimeter sidewall of the panel that extends between the lower wall and the upper wall, and the upper and lower interior cavities are in communication with each other such that they together form an interior space of the panel, with the interior space being defined within the lower wall, the upper wall, and the perimeter sidewall. Additionally, the panel further comprises complementary locking structures arranged on opposite sides of the perimeter sidewall; and a lower alignment structure extends upward from the lower wall and an upper alignment structure extending downward from the upper wall, the upper and lower alignment structures being complementary with each other to facilitate alignment of the upper and lower shells. The method further includes joining the lower shell and the upper shell together. The method further includes injecting an insulation material within the interior space.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a perspective top view of an ice protection panel, according to one or more embodiments of the present disclosure.

FIG. 2 is a perspective bottom view of the ice protection panel of FIG. 1.

FIG. 3 is a perspective top view of a lower shell of the ice protection panel of FIGS. 1-2 depicting an interior cavity of the lower shell.

FIG. 4 is a perspective bottom view of an upper shell of the ice protection panel of FIGS. 1-2 depicting an interior cavity of the upper shell.

FIG. 5A is a cross-sectional view of the panel of FIG. 1 about section line 5C-5C depicting internal structure thereof, according to one or more embodiments of the present disclosure.

FIG. 5B is a close-up cross-sectional view of a portion of the panel of FIG. 5A.

FIG. 6A is an end view of the panel of FIG. 1.

FIG. 6B is an enhanced of a first side of the panel of FIG. 6A.

FIG. 6C is an enhanced of a second side of the panel of FIG. 6A.

FIG. 7A is a side view of the panel of FIG. 1.

FIG. 7B is an enhanced view of a first end of the panel of FIG. 7A.

FIG. 7C is an enhanced view of a second end of the panel of FIG. 7A.

FIGS. 8A-8D are enhanced views of corners of the panel of FIG. 1, according to embodiments.

FIG. 9 illustrates a top view of a panel system including panels shown in FIG. 1 assembled together.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to ground surface protection and, more particularly, to methods and systems for protecting and insulating the ice in an ice rink. The embodiments disclosed herein include a panel that is placed on a surface of the ice. The panel may include a lower shell, an upper shell, and an insulation arranged between the upper and lower shells. The upper and lower shells may have alignment structures for facilitating alignment between the upper and lower shells when assembling the panel. Injection ports may be defined in a perimeter sidewall of the panel when the upper and lower shells are assembled together. An insulation material may be injected into the panel through the injection ports. Also, the panel may include complementary locking structures arranged on opposite sides of the perimeter sidewall to facilitate interlocking the panel with an adjacent panel placed on the ice. For example, the panel may include a first side and a second side opposite the first side, and the complementary locking structures permit the first side of the panel being operatively engaged with the second side of an adjacent panel. In addition to the first and second sides, the perimeter sidewall of the panel may further include opposite ends, such as a first end and a second end opposite the first end, and complementary locking structures may also be arranged on the opposite ends of the panel such that the first end of the panel may be operatively engaged with the second end of another adjacent panel. The complementary locking structures of adjacent panels, when engaged and attached together, form or define a joint having serpentine or tortuous path that inhibits fluids from leaking through the joint and onto the ice underlying the panels.

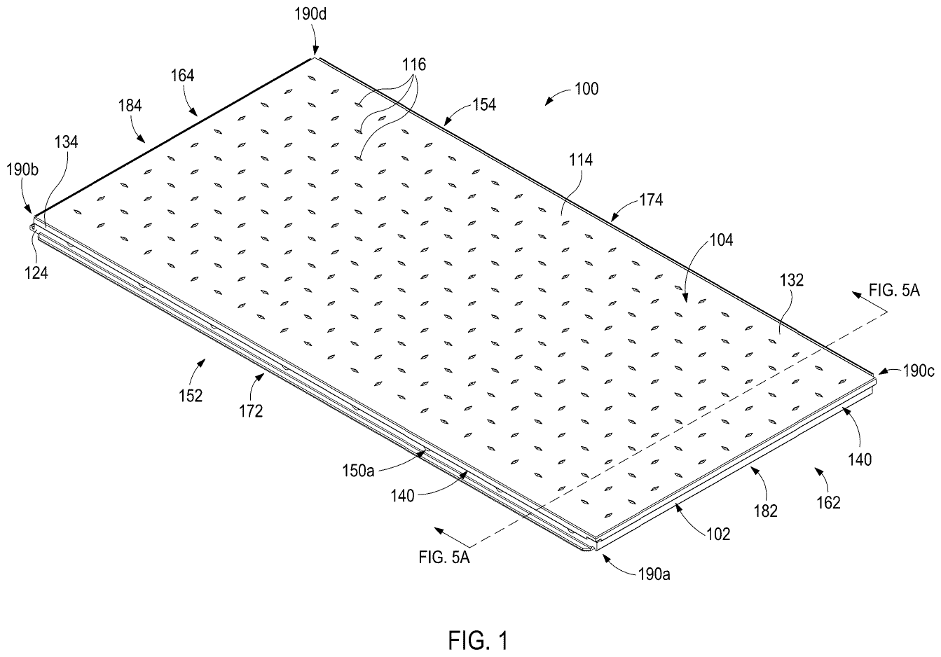

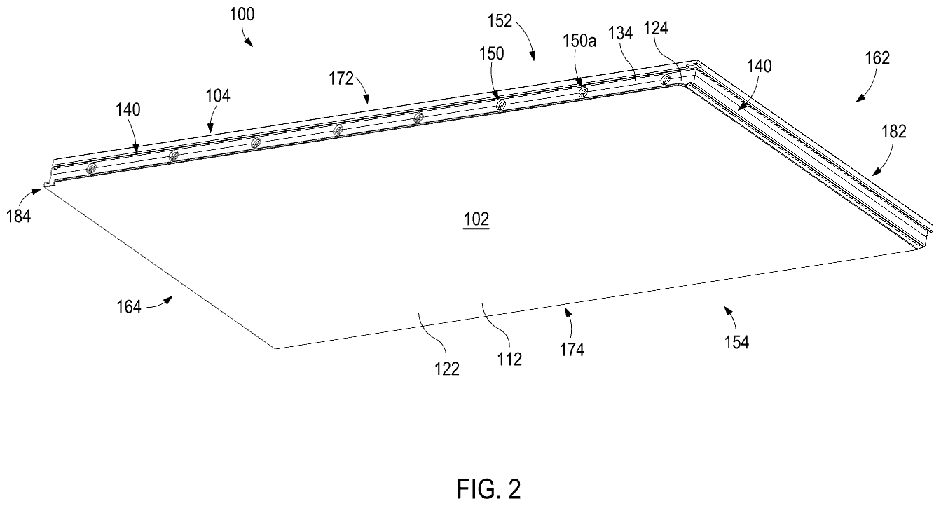

FIG. 1 is a perspective top view of an ice protection panel 100, according to one or more embodiments of the present disclosure. FIG. 2 is a perspective bottom view of the ice protection panel 100 of FIG. 1. As hereinafter described, the ice protection panel 100 (hereinafter, “the panel 100”) may be laid on top of the ice in an ice rink to inhibit damage to the underlying ice while people walk on top of the panel 100, equipment is moved on top of the panel 100, and/or machinery (e.g., front end loader) is driven across the top of the panel 100. The panel 100 simultaneously insulates the underlying ice from higher temperatures that may be exhibited above the panel 100 to inhibit melting of the ice.

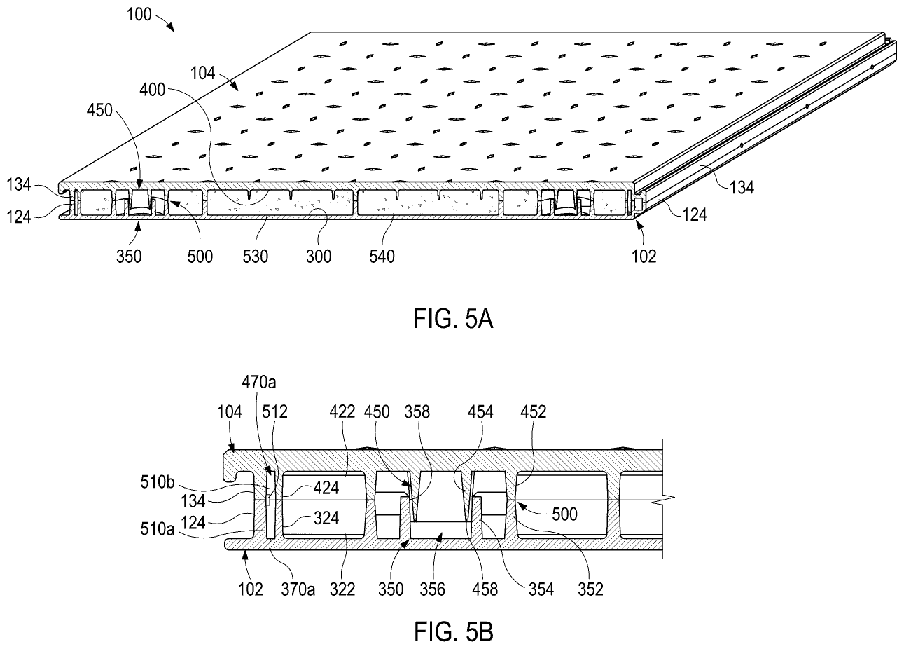

As shown in FIGS. 1-2, the panel 100 includes a lower shell 102, and a upper shell 104, and an insulation material (obscured from view in FIGS. 1-2; see insulation material 540 in FIG. 5A) contained within/inside the panel 100. In particular, the insulation material is contained within an interior space defined inside the panel 100 when the lower and upper shells are joined/attached/assembled together as detailed herein. To manufacture the panel 100, the lower and upper shells 102 and 104 are formed (e.g., via molding), and then the lower and upper shells 102 and 104 are attached together (e.g., via welding) to form a single unit. Thereafter, the insulation material is arranged in the interior space of the panel 100 (e.g., via injecting) to thereby provide the panel 100 with insulating properties.

In some embodiments, the material of the upper and lower shells 102, 104 may be selected based on desired structural properties of the panel 100, such as providing a durable structure to protect the ice and support loads placed thereon. Additionally, the material of the upper and lower shells 102, 104 may be selected based on insulation characteristics. In embodiments, the shells 102, 104 are each made from a high density polyethylene (HDPE) material and formed through a low-pressure structural foam injection molding process. The insulation material may be any suitable insulation material. In an embodiment, the insulation material is a polyurethane-based foam material. In some embodiments, the fully assembled panel 100 with the insulation material disposed within has an R-value of at least 8 (e.g., RSI value of at least 1.4). Thus, the panel 100 is formed from materials durable enough to protect the ice and support loads placed thereon while having superior insulating qualities as compared to conventional insulated panels.

The panel 100 includes a lower outer surface 112 (FIG. 2) and an upper outer surface 114 (FIG. 1). When the panel 100 is in use, the panel 100 is placed on an ice surface such that the lower outer surface 112 contacts/abuts the ice. The upper outer surface 114 is arranged opposite the lower outer surface 112 and provides the surface on which events may be conducted, users may walk, and equipment may be placed/moved without damaging the ice. Accordingly, the upper outer surface 114 may be textured or include traction elements to provide traction on the upper outer surface 114. For example, the upper outer surface 114 may have traction elements in the form of treads 116 as shown in FIG. 1. The lower outer surface 112, however, may be smooth planar surface with a low coefficient of friction to protect the surface of the ice.

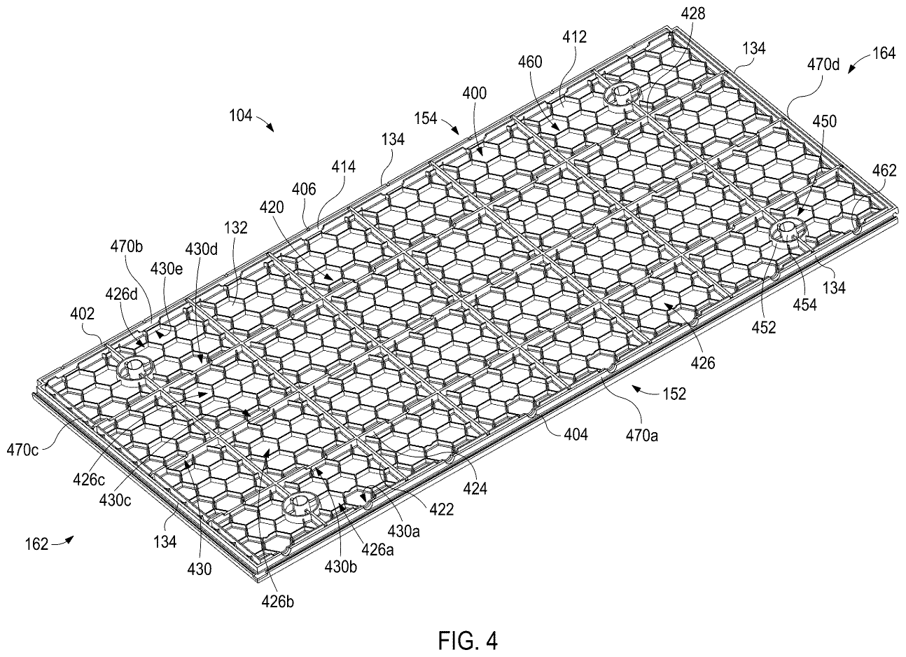

As shown in FIG. 1, the upper shell 104 includes an upper wall 132 and an upper peripheral sidewall 134 around the perimeter of the upper wall 132 that extends downwards from the upper wall 132. The upper outer surface 114 is defined on an exterior of the upper wall 132. The upper wall 132 and the upper peripheral sidewall 134 together define an upper interior cavity 400 of the upper shell 104, as better described with reference to FIG. 4, which depicts the upper shell 104 when disassembled from the lower shell 102.

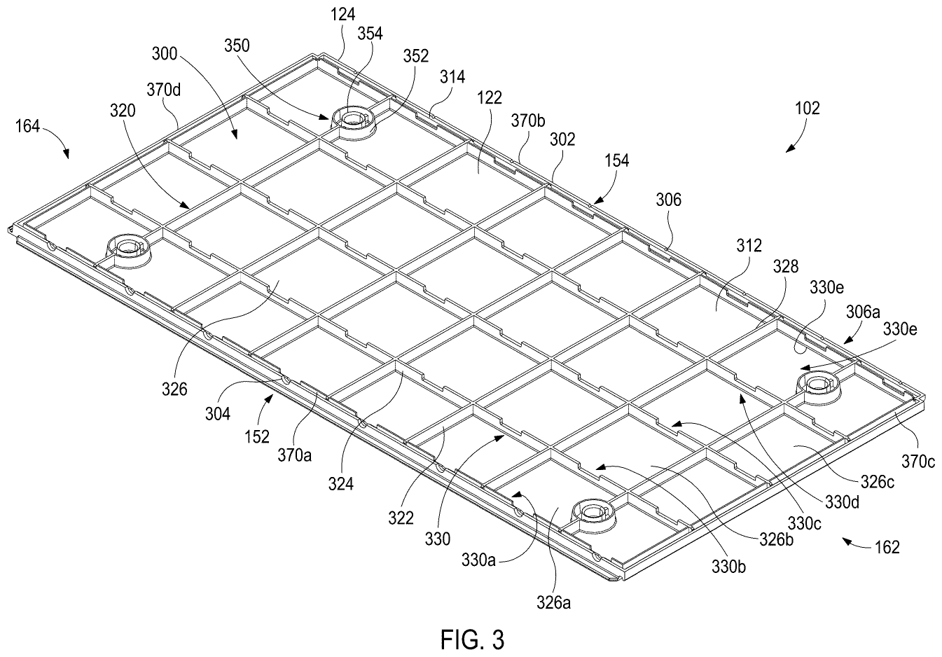

As shown in FIG. 2, the lower shell 102 includes a lower wall 122 and a lower peripheral sidewall 124 around the perimeter of the lower wall 122 that extends upward from the lower wall 122. The lower outer surface 112 is defined on an exterior of the lower wall 122, as shown in FIG. 2. The lower wall 122 and the lower peripheral sidewall 124 together define a lower interior cavity 300 of the lower shell 102, as better described with reference to FIG. 3, which depicts the lower shell 102 when disassembled from the upper shell 104.

When the lower shell 102 and the upper shell 104 are assembled together to form the panel 100, as shown in FIGS. 1-2, the lower peripheral sidewall 124 and the upper peripheral sidewall 134 abut/contact each other, and are joined together during manufacture, for example, via welding. When the lower peripheral sidewall 124 and the upper peripheral sidewall 134 are arranged and assembled together in this manner, they together define a perimeter sidewall 140 of the panel 100. Additionally, the lower and upper interior cavities 300, 400 define the interior space (see interior space 530 in FIG. 5A) that is fillable with the insulation material when the lower and upper shells 102, 104 are assembled together.

As shown in FIG. 1, the perimeter sidewall 140 extends around the circumference/perimeter of the panel 100, and the perimeter sidewall 140 also extends between the lower wall 122 and the upper wall 132. In this manner, the perimeter sidewall 140, together with the lower and upper walls 122 and 132, substantially enclose and constrain the interior space inside of the panel 100 within which the insulation material is provided.

In the illustrated embodiment, the panel 100 has a rectangular shape. Accordingly, the perimeter sidewall 140 of the panel 100 is comprised of a first pair of opposite sides 152, 154, and a second pair of opposite sides 162, 164 (however, the second pair of opposite sides may alternatively be referred to as a pair of opposite ends 162, 164), that all together define the outline or perimeter of a rectangular structure. While the panel 100 is depicted as being rectangular in shape, the panel 100 may have other shapes in other embodiments, such as being square shaped. Also, when a plurality of the panels 100 are utilized to cover the ice in an ice rink having a non-rectangular or non-square shape, panels 100 may be cut so as to conform to the shape of the ice rink. Stated differently, the panel 100 may be cut down so that it has a curved shape that corresponds to the curved sides in a hockey rink.

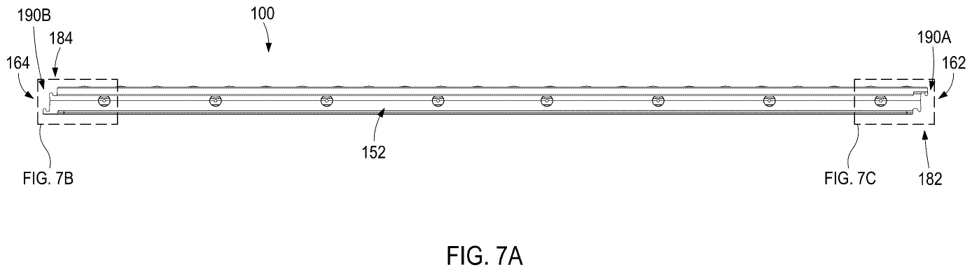

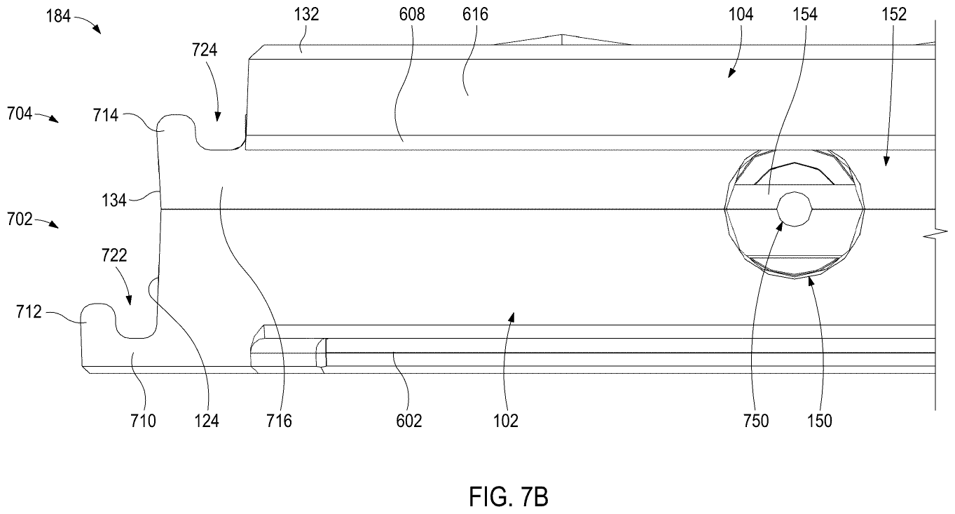

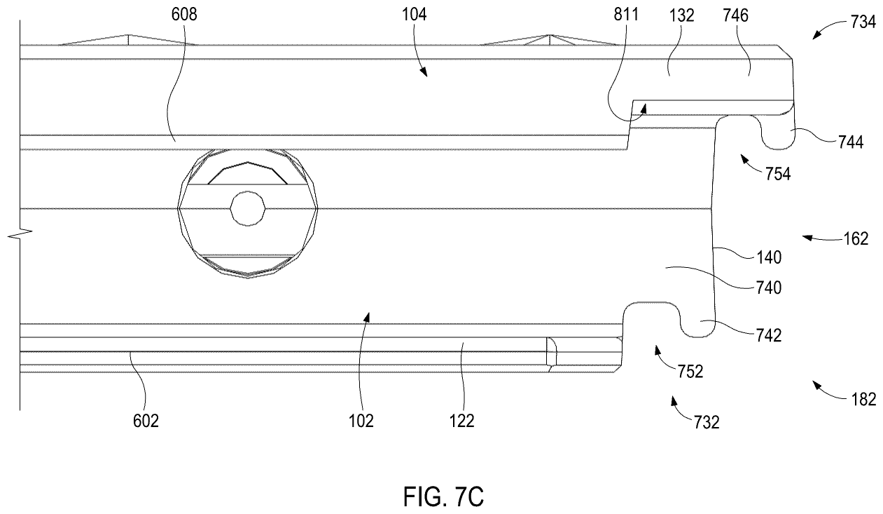

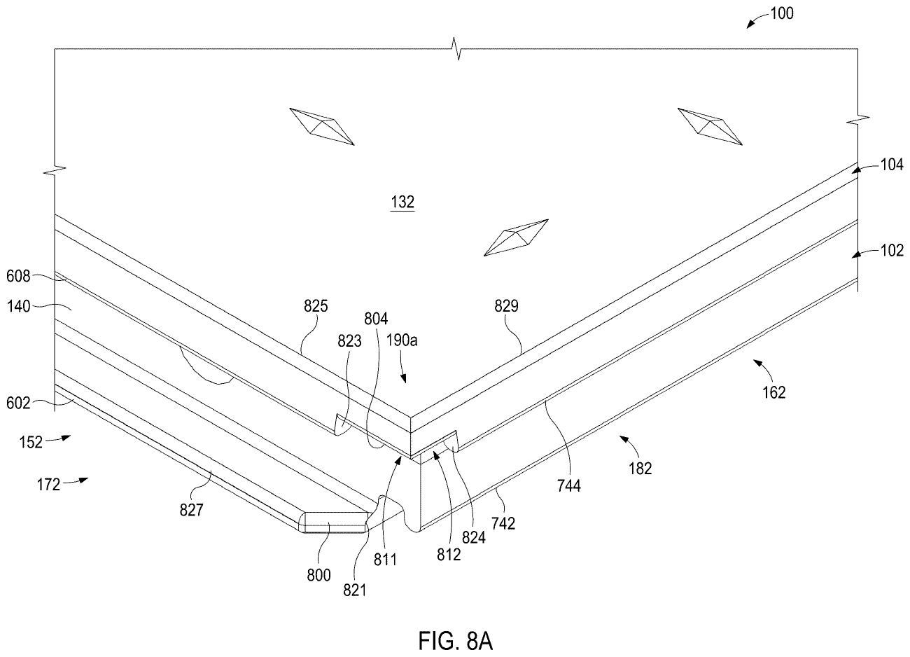

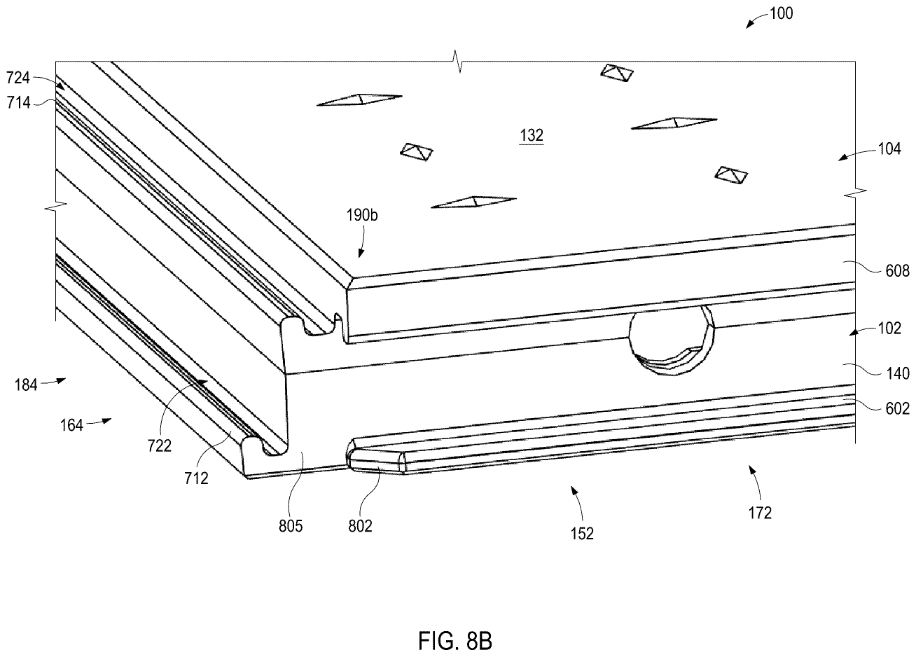

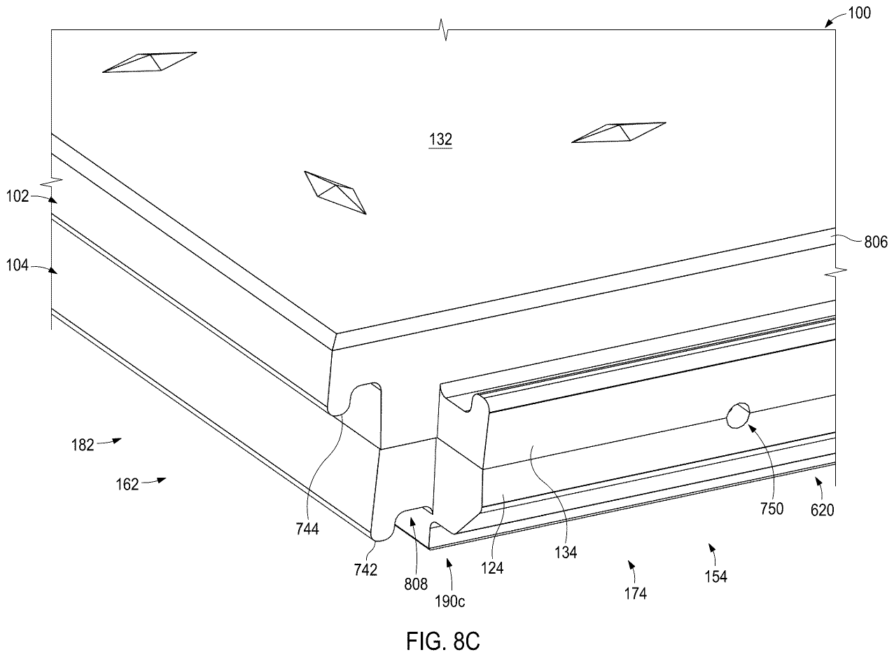

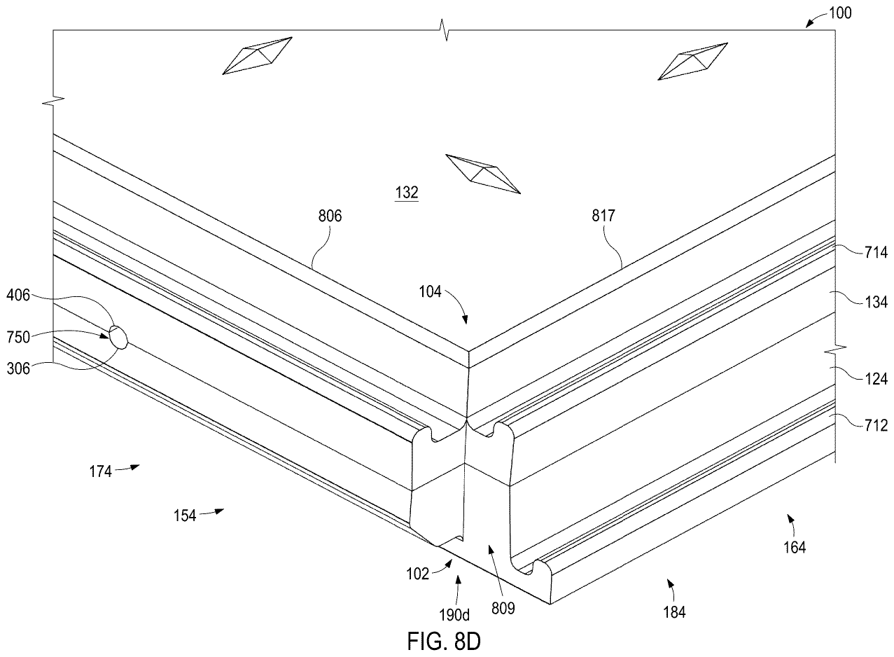

In some embodiments, the panel 100 includes one or more injection ports 150 formed in the perimeter sidewall 140 in communication with the interior space. The insulation material may be injected into the interior space through the injection ports 150. The panel 100 may also include pressure release ports 750 (obscured from view in FIGS. 1-2, see FIGS. 7B and 8D) to facilitate injection of the insulation material by providing a path through which gases (e.g., atmospheric air) may escape as the interior space of the panel 100 is filled with the insulation material. In the illustrated embodiment, the injection ports 150 are formed on a first side 152 and the corresponding pressure release ports (obscured from view) are formed on a second side 154. However, the injection ports 150 may instead be provided on the second side 154 with the pressure release ports 750 being provided on the first side 152. In some embodiments, the injection ports 150 and pressure release ports 750 may be provided on of the opposite ends 162, 164 rather than the first and second sides 152, 154. In other embodiments, one or more of the pressure release ports 750 may be formed on the same side as the perimeter sidewall 140 as the injection ports 150 or on a non-opposing side of the perimeter sidewall 140 from the injection ports 150. For example, the injection ports 150 may be formed on the first side 152 while the pressure release ports 750 are formed on one of the opposite ends 162, 164. In other embodiments, the injection ports 150 may be formed on multiple sides of the perimeter sidewall 140, such as being provided on the first side 152 and the first end 162.

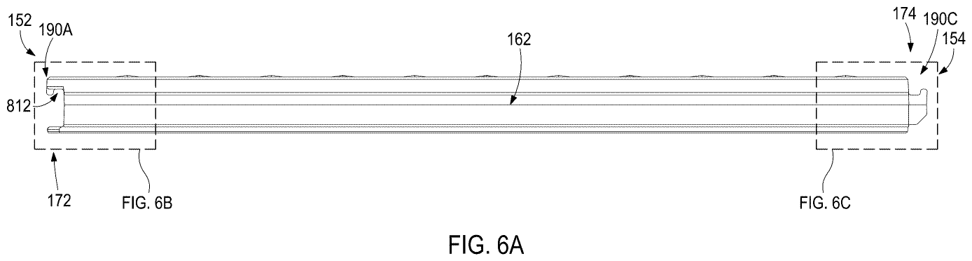

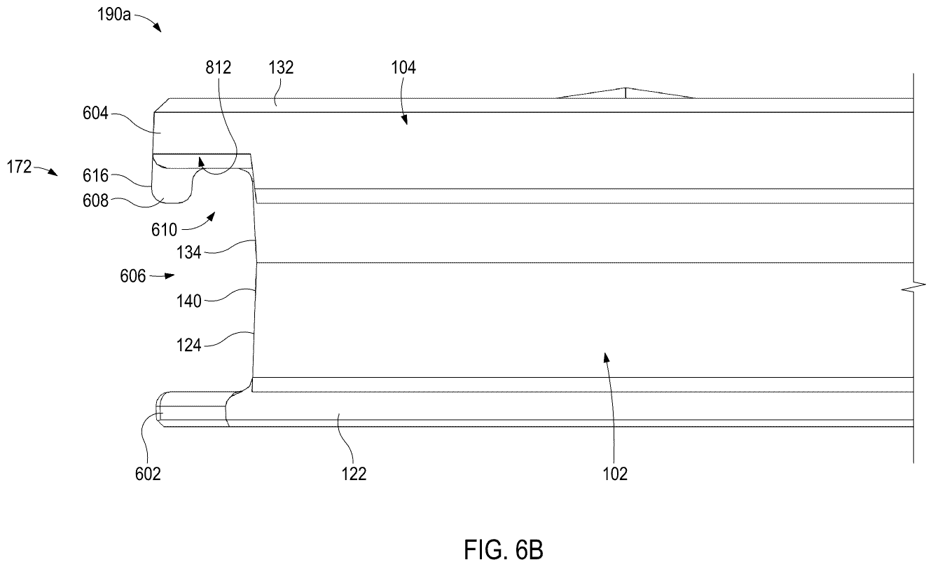

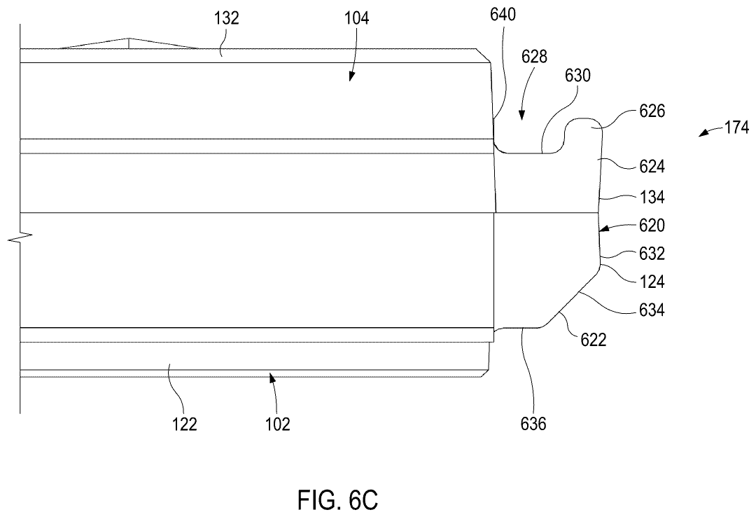

The panel 100 may be part of a panel system, wherein the panel system is comprises of a plurality of the panels 100. Accordingly, the panel 100 is designed to be attachable/matable with other panels 100. To facilitate connection between adjacent panels 100, the panel 100 may include complementary locking structures on opposite sides of the perimeter sidewall 140. While the structure of the complementary locking structures is further detailed below with reference to FIGS. 6A-6C and FIGS. 7A-7C, the complementary locking structures of the illustrated embodiment includes a first pair of complementary locking structures 172 and 174 on the first side 152 and the second side 154, respectively, and a second pair of complementary locking structures 182 and 184 on the first end 162 and the second end 164. Thus, in example where there is a first panel and a second panel that are each configured as described with reference to the panel 100, the locking structure 172 on the first side 152 of the first panel 100 may mate with the locking structure 174 on the second side 154 of the second panel 100 or vice versa, and the locking structure 182 on the first end 162 of the first panel 100 may mate with the locking structure 184 on the second end 164 of the second panel 100 or vice versa. Accordingly, the locking structure 172 is complementary in shape/structure to the locking structure 174, such that the locking structure 172 on a first panel 100 is connectable with the complementary locking structure 174 on a second panel 100; and, similarly, the locking structure 182 is complementary in shape/structure to the locking structure 184, such that the locking structure 182 on a first panel 100 is connectable with the complementary locking structure 184 on a second panel 100.

FIG. 3 depicts the lower shell 102 when the upper shell 104 has been removed therefrom to thereby expose a lower cavity 300, according to one or more embodiments. As previously mentioned, the lower shell 102 includes the lower cavity 300 that is defined by the lower wall 122 and the lower peripheral sidewall 124. As shown, the lower wall 122 includes a lower inner surface 312 defined on an interior of the lower wall 122 (that is opposite the outer surface 112), and the lower peripheral sidewall 124 includes an inner facing surface 314. The lower cavity 300 is the interior space of the lower shell 102 that is defined between the lower inner surface 312 and inner facing surface 314.

FIG. 4 depicts the upper shell 104 when the lower shell 102 has been removed therefrom to thereby expose an upper cavity 400, according to one or more embodiments. As previously mentioned, the upper shell 104 includes the upper cavity 400 that is defined by the upper wall 132 and the upper peripheral sidewall 134, and the upper cavity 400 is exemplified in FIG. 4. As shown, the upper wall 132 includes an upper inner surface 412 defined on an interior of the upper wall 132 (that is opposite the outer surface 114), and the upper peripheral sidewall 134 includes an inner facing surface 414. The upper cavity 400 is the interior space of the upper shell 104 that is defined between the upper inner surface 412 and inner facing surface 414.

Referring again to FIGS. 1-2, when the lower and upper shells 102 and 104 are joined together, the lower cavity 300 and the upper cavity 400 are in communication with each other such that they together form the interior space of the panel 100, within which the insulation material is arranged. Further, the interior space of the panel 100 is defined within the lower wall 122, the upper wall 132, and the perimeter sidewall 140. More specifically, the interior space of the panel 100 is defined by the lower inner surface 312 and inner facing surface 314 of the lower shell 102 and the upper inner surface 412 and inner facing surface 414 of the upper shell 104.

As shown in FIG. 3, the lower peripheral sidewall 124 of the lower shell 102 includes an upper edge 302. Similarly, as shown in FIG. 4, the upper peripheral sidewall 134 of the upper shell 104 includes a lower edge 402. When the panel 100 is assembled, the upper edge 302 of the lower peripheral sidewall 124 and the lower edge 402 of the upper peripheral sidewall 134 are aligned and joined together.

In some embodiments, a portion of each injection ports 150 is defined by the peripheral sidewalls 124, 134 of the assembled lower and upper shells 102, 104. As shown in FIG. 3, a lower portion 304 of the injection port 150 is formed/defined in the upper edge 302 of the lower peripheral sidewall 124 of the lower shell 102. Similarly, an upper portion 404 of the injection port 150 is formed/defined in the lower edge 402 of the upper peripheral sidewall 134 of the upper shell 104 as shown in FIG. 4. The lower and upper portions 304, 404 of the injection ports 150 are formed at locations in the edges 302, 402 such that they are in alignment with each other upon joining the shells 102, 104 to fully define the injection ports 150. In some embodiments, some or all of the injection ports 150 may be fully defined within the lower or upper shells 102, 104 instead of being partially defined by both of the lower and upper shells 102, 104.

In some embodiments, the pressure release ports 750 (FIGS. 7B and 8D) are similarly defined by the peripheral sidewalls 124, 134 of the assembled lower and upper shells 102, 104. As shown in FIG. 3, a lower portion 306 of the pressure release port 750 is formed/defined in the upper edge 302 of the lower peripheral sidewall 124 of the lower shell 102. Similarly, an upper portion 406 of the pressure release port 750 is formed/defined in the lower edge 402 of the upper peripheral sidewall 134 of the upper shell 104 as shown in FIG. 4. The lower and upper portions 306, 406 of the pressure release port 750 are formed at locations in the edges 302, 402 such that they are in alignment with each other upon joining the shells 102, 104, to thereby fully define each pressure release port 750. In some embodiments, some or all of the pressure release ports 750 may be fully defined within the lower or upper shells 102, 104 instead of being partially defined by both of the lower and upper shells 102, 104.

In the illustrated embodiment, the location of the pressure release ports 750 on the second side 154 correspond with the location of the injection ports 150 on the first side 152, such that the injection ports 150 are in alignment with the pressure release ports 750. Thus, each of the lower portions 304 of the injections ports 150 is aligned with one of the lower portions 306 of the pressure release ports, as shown in FIG. 3, and each of the upper portions 404 of the injections ports 150 is aligned with one of the upper portions 406 of the pressure release ports, as shown in FIG. 4.

In the illustrated embodiment, the lower shell 102 and the upper shell 104 each include a corresponding grid structure 320, 420 arranged in the lower cavity 300 and the upper cavity 400, respectively. The lower grid structure 320 shown in FIG. 3 is formed of a plurality of intersecting interior ribs 322 and 324. Here, the ribs 322 extend between the first side 152 and the second side 154, and the ribs 324 extend between the first end 162 and the second end 164, and the ribs 322, 324 intersect each other to form a plurality of square/rectangular shaped compartments 326 that will each be filed with the insulation material. Further, the ribs 322 extend between and abut/contact the opposite sides 152, 154 of the lower peripheral sidewall 124, and the ribs 324 extend between and abut/contact the opposite sides 162, 164 of the lower peripheral sidewall 124. Moreover, one or more lower gaps may exist between an interior surface of the lower peripheral sidewall 124 and an outer facing surface of the lower grid structure 320. For example, a first lower gap 370A may be formed between the rib 324 closest to the first side 152 and the lower peripheral sidewall 124, a second lower gap 370B may be formed between the rib 324 closest to the second side 154 and the lower peripheral sidewall 124, a third lower gap 370C may be formed between the rib 322 closest to the first end 162 and the lower peripheral sidewall 124, and a fourth lower gap 370D may be formed between the rib 322 closest to the second end 164 and the lower peripheral sidewall 124. The lower gaps are in communication with at least one of the injection ports 150 when the panel 100 is assembled to facilitate filling the gaps with the insulation material.

Referring to FIG. 4, upper grid structure 320 is formed of a plurality of intersecting interior ribs 422 and 424. Here, the ribs 422 extend between the first side 152 and the second side 154, and the ribs 424 extend between the first end 162 and the second end 164, and the ribs 422, 424 intersect each other to form a plurality of square/rectangular shaped compartments 426 that will each be filed with the insulation material. Further, the ribs 422 extend between and abut/contact the opposite sides 152, 154 of the upper peripheral sidewall 134, and the ribs 424 extend between and abut/contact the opposite sides 162, 164 of the upper peripheral sidewall 134. Moreover, one or more upper gaps may exist between an interior surface of the upper peripheral sidewall 134 and an outer facing surface of the upper grid structure 420. For example, a first upper gap 470A may be formed between the rib 424 closest to the first side 152 and the upper peripheral sidewall 134, a second upper gap 470B may be formed between the rib 424 closest to the second side 154 and the upper peripheral sidewall 134, a third upper gap 470C may be formed between the rib 422 closest to the first end 162 and the upper peripheral sidewall 134, and a fourth upper gap 470D may be formed between the rib 422 closest to the second end 164 and the upper peripheral sidewall 134. The upper gaps are in communication with at least one of the injection ports 150 when the panel 100 is assembled to facilitate filling the gaps with the insulation material. Additionally, the upper gaps 470A-470D are aligned with a corresponding lower gap 370A-370D when the panel 100 is assembled, with the first upper gap 470A being complementary to the first lower gap 370A, the second upper gap 470B being complementary to the second lower gap 370B, the third upper gap 470C being complementary to the third lower gap 370C, and the fourth upper gap 470D being complementary to the fourth lower gap 370D.

In the illustrated embodiment, the lower grid structure 320 is complementary to the upper grid structure 420 such the ribs 322, 324 of the lower grid structure 320 are aligned and in contact with the ribs 422, 424 of the upper grid structure 420 when the shells 102, 104 are assembled together, and vice versa. Thus, the compartments 326 defined in the lower shell 102 will be in alignment with the corresponding compartments 426 defined in the upper shell 104 when the shells 102, 104 are assembled together, with the compartments 326 and 426 together defining relatively larger interior compartments/cells that will be filled with insulation when the panel 100 is assembled. Additionally, some of the load applied to the upper shell 104 is transferred to the lower shell 102 by the interface between the abutting ribs of the lower and upper grid structures 320, 420.

As shown in FIG. 3, the ribs 322, 324 of the lower grid structure 320 extend upward the same distance from the lower inner surface 312 of the lower wall 122 so that the lower grid structure 320 has an upper edge 328 that is substantially uniform in distance from the lower inner surface 312. However, in the illustrated embodiment, lower flow gaps 330 are formed in the upper edge 328 along the ribs 324. In embodiments, similar flow gaps may also be provided in the ribs 322. Also in the illustrate embodiment, the lower grid structure 320 extends upward form the lower inner surface 312 at a substantially equal distance as the lower peripheral sidewall 124, such that the upper edge 302 and the upper edge 328 are located at substantially equal distances from the lower inner surface 312. However, in other embodiments, the upper edge 302 of the lower peripheral sidewall 124 may extend further or lesser from the lower inner surface 312 than the upper edge 328.

As shown in FIG. 4, the ribs 422, 424 of the upper grid structure 420 similarly extend downward the same distance from the upper inner surface 412 of the upper wall 132 so that the upper grid structure 420 has a lower edge 428 that is substantially uniform in distance from the upper inner surface 412. However, in the illustrated embodiment, upper flow gaps 430 are formed in the lower edge 428 along the ribs 424. In embodiments, similar flow gaps may also be provided in the ribs 422. Also in the illustrate embodiment, the upper grid structure 420 extends downward form the upper inner surface 412 at a substantially equal distance as the upper peripheral sidewall 134, such that the lower edge 402 and the lower edge 428 are located at substantially equal distances from the upper inner surface 412. However, in other embodiments, the lower edge 402 of the upper peripheral sidewall 134 may extend further or lesser from the upper inner surface 412 than the lower edge 428.

When the lower and upper shells 102, 104 are assembled together, the edges 328, 428 of the grid structures 320, 420 abut/contact each other. Also, the lower and upper flow gaps 330, 430 are formed on their respective ribs 324, 424 such that the flow gaps 330, 430 are in alignment with each other when the grid structures 320, 420 are brought into alignment and contact with each other, to thereby define interior flow windows. Stated differently, each of the lower flow gaps 330 in defined in the upper edge 328 of the rib 324 is aligned with a corresponding one of the upper flow gaps 440 defined in the lower edge 428 of the rib 424 when the panel 100 is assembled by aligning and connecting the lower shell 102 with the upper shell 104, such that interior flow windows are formed in the interior grid structure of the panel 100 to allow insulation material to fill each of the cells defined by the grid structures 320, 420. Each interior flow window is aligned with a corresponding injection port 150. In some embodiments, each interior flow window is aligned with an injection port 150 and a pressure release port 750.

Accordingly, when the panel 100 is assembled in this manner, insulation material may fill the panel 100 as follows. First, the insulation material may be injected into a first injection port 150A (of the injection ports 150, see FIGS. 1-2), such insulation material will enter the interior space of the panel 100 via the first injection port 150A. The insulation material may then flow through a first interior flow window (defined by first flow gaps 330A, 430A when the edges 328, 428 are brought into contact with each other) and then the insulation material will flow into a first interior cell (defined by compartments 326A and 426A when the edges 328, 428 are brought into contact with each other). The insulation material will fill up the entirety of first interior cell and, once the first interior cell is completely filled with the insulation material, the insulation material will then flow through a second interior flow window (defined by second flow gaps 330B, 430B) and into a second interior cell (defined by second compartments 326B and 426B). The insulation material will fill up the entirety of second interior cell and, once the second interior cell is completely filled with the insulation material, the insulation material will then flow through a third interior flow window (defined by third flow gaps 330C, 430C) and into a third interior cell (defined by third compartments 326C and 426C). The insulation material will fill up the entirety of third interior cell and, once the third interior cell is completely filled with the insulation material, the insulation material will then flow through a fourth interior flow window (defined by fourth flow gaps 330D, 430D) and into a fourth interior cell (defined by fourth compartments 326D and 426D). Thereafter, the insulation material will fill up the entirety of fourth interior cell and, once the fourth interior cell is completely filled with the insulation material, the insulation material will then flow through a fifth interior flow window (defined by fourth flow gaps 330E, 430E) and into any portion of the interior space of the panel 100 that is exterior of the joined grid structures 320, 420 in communication with the first injection port 150A. The insulation material will eventually start to exit the panel 100 via any one or more of the pressure release ports (defined by the portions 306, 406) once the insulation material has completely filled the interior space defined in the panel 100 in communication with the first injection port 150A. Not only may these pressure release ports provide visual indication of when the panel 100 is complete filled with the insulation material, such that injection of the insulation material into the panel 100 may be ceased, but the pressure release ports allow air or any other gases contained in the panel 100 to be evacuated and discharged as the insulation material enters the panel and displaces such gas/air.

In the illustrated embodiments, the interior flow windows are formed only in the ribs 324 and 424, but not in the ribs 322, 422. In this manner, the interior cells of the panel 100 are arranged in rows, with each row having a plurality of cells and starting at the first side 152 and ending at the second side 154 of the panel 100, and with each interior cell of a particular row of cells being in communication with the other interior cells of that particular row. In other words, each row may be isolated from one another due to the welding between the abutting ribs 322, 422. In the illustrated example, the rows of interior cells includes a first row of interior cells bordering the first end 162, a second row of interior cells bordering the first row and being closer to the second end 164 than the first row, a third row of interior cells bordering the second row and being closer to the second end 164 than the second row, a fourth row of interior cells bordering the third row and being closer to the second end 164 than the third row, a fifth row of interior cells bordering the fourth row and being closer to the second end 164 than the fourth row, a sixth row of interior cells bordering the fifth row and being closer to the second end 164 than the fifth row, a seventh row of interior cells bordering the sixth row and being closer to the second end 164 than the sixth row, and an eighth row of interior cells bordering the seventh row and also bordering the second end 164. In the above example that discusses the first injection port 150A, the row of interconnected interior cells associated with that injection port 150A would be the second row of interior cells. As can be seen, this arrangement of the interior flow windows thereby directs the flow of insulation material from the injection port 150A into the second row of interconnected interior cells and, more specifically, into a first cell bordering the first side 152, and from the first cell into a second cell that is closer to the second side 154 than the first cell, and from the second cell into a third cell that is closer to the second side 154 than the second cell, and from the third cell into a fourth cell that is closer to the second side 154 than the third cell, and then out of the panel 100 via the pressure relief port 750. Thus, each row of interior cells of the panel 100 may be filled with insulation material separate from the other rows of interior cells.

In other examples, interior flow windows may be formed in the ribs 322, 422 to allow the insulation material to flow from one row of interior cells into a neighboring row of interior cells. In other words, each row may not be isolated from bordering rows due to the interior flow windows formed in the ribs 322, 422.

In the illustrated embodiment shown in FIG. 4, the upper shell 104 further includes a honey comb structure 460 arranged in the upper cavity 400 thereof. In the illustrated embodiment, the honey comb structure 460 extends downward from the upper inner surface 412 of the upper wall 132 and enhances the structural integrity of the upper wall 132, and the panel 100 as a whole when assembled. Here, the honey comb structure 460 is formed of a plurality of ribs that together define the honey comb structure 460, and a portion of the honey comb structure 460 is arranged in each of the compartments 426. The honey comb structure 460 extends downward from the upper inner surface 412 to a lesser extent than do the ribs 422, 424 such that the honey comb structure 460 does not interfere with (or fully obstruct) the flow of the insulation material as the insulation material fills up each of the interior cells in each of the rows of cells, as detailed above. As best shown in FIG. 4, the portion of the ribs making up the honey comb structure 460 proximate to the injection ports 150 may include a gap or recessed portion 462, so as to ensure that no portion of the honey comb structure 460 impedes or obstructs the flow of insulation material into the interior space of the panel 100 through the injection ports 150.

The lower shell 102 and the upper shell 104 are configured to be easily aligned with each other. In the illustrated embodiment, the lower shell 102 includes a lower alignment structure 350 (FIG. 3) extending upward from the lower wall 122 and an upper alignment structure 450 (FIG. 4) extending downward from the upper wall 132. The alignment structures 350, 450 are complementary with each other to facilitate alignment of the upper and lower shell 104, 102, such that they may fit together and thereby help ensure that the upper and lower shells 104, 102 are properly aligned during manufacture/assembly and, moreover, may provide another means for providing internal structural support to the panel 100 so that it may withstand large force applied to upper outer surface 114.

Referring back to FIG. 3, the lower alignment structure 350 includes a pair of concentric rings 352, 354 that extend upward from the lower wall 122. The outer ring 352 of the lower alignment structure 350 extends upward from the lower wall 122 the same distance as the grid structure 320 and associated ribs 322, 324. Referring back to FIG. 4, the upper alignment structure 450 similarly includes a pair of concentric rings 452, 454 that extend downward from the upper wall 132, as shown in FIG. 4. The outer ring 452 of the upper alignment structure 450 similarly extends downward from the upper wall 132 the same distance as the grid structure 420 and associated ribs 422, 424.

FIGS. 5A and 5B are cross-sectional views of the panel 100 that depict interaction of the alignment structures 350, 450, according to an embodiment of the present disclosure. Here, the upper and lower alignment structures 350, 450 contact each other and together define a structural column 500 within the interior space of the panel 100 when the lower shell 102 and the upper shell 104 are assembled together. An upper edge of the outer ring 352 is the same distance from the lower wall 122 as the upper edge 328 of the grid structure 320, and a lower edge of the outer ring 452 is the same distance from the upper wall 132 as the upper edge 428 of the grid structure 420. Accordingly, when the upper and lower shells 104, 102 are assembled together, the upper edge of the outer ring 352 (of the lower alignment structure 350) abuts/contacts the lower edge of the outer ring 452 (of the upper alignment structure 450), so that the lower outer ring 352 and the upper outer ring 452 together define the structural support column 500 which provides further strength for bearing loads placed on the upper outer surface 114.

Additionally, the inner rings 354 and 454 of the alignment structures 350, 450 provide the alignment function. As shown in FIGS. 5A-5B, the upper inner ring 454 of the upper alignment structure 450 has a smaller diameter than the lower inner ring 354 of the lower alignment structure 350, such that the upper inner ring 454 may fit inside of a bore 356 defined by the lower inner ring 354. When upper inner ring 454 is inside of the bore 356 defined of the lower inner ring 354, the upper and lower shells 104 and 102 are properly aligned. Thus, when the lower inner ring 354 and the upper inner ring 454 are aligned with each other, the upper inner ring 454 is nested inside the lower inner ring 354, which in turn results in alignment of the lower and upper shells 102, 104 during assembly of the panel 100. Here, the upper inner ring 454 extends downward from the upper wall 132 a further distance than the outer ring 452, and the upper inner ring 454 extends downward from the upper wall 132 a further distance than the distance at which the inner ring 354 extends upward from the lower wall 122, so as to create an overlap in length between the inner rings 354 and 454 and ensure that a length of the upper outer ring 454 extends into the lower outer ring 354. In the illustrated embodiment, an upper edge 358 of the lower inner ring 354 includes a chamfer or is rounded so as to help guide a lower edge 458 of the upper inner ring 454 into the bore 356 when attempting to align the shells 102 and 104. FIG. 5B depicts how the upper inner ring 454 overlaps the lower inner ring 354, as the upper inner ring 454 extends into the bore 356 of the lower inner ring 354 with lower edge 458 of the upper inner ring 454 extending beyond the upper edge 358 of the lower inner ring 354.

FIG. 5A additionally shows a portion of the inner space 530 defined by the upper and lower cavities 300, 400 that is filled with insulation material 540 which is shown as foam that cured after being injected through one of the injection ports 150. In the illustrated embodiment, the support column 500 has a space defined within the adjoining centric rings 352, 452 and a space within the connected lower and upper rings 354, 454 is filled with a gas, such as air, rather than the insulation material 540. In other embodiments, the insulation material is introduced into these spaces within the support column 500, such as by one or more access ports formed in at least one of the centric rings 352, 452 and at least one of the lower and upper rings 354, 454.

FIG. 5B also shows the aligned lower and upper gaps 370A, 470A that are shown without insulation material 540 disposed within to better show buttress walls 510a,b. Insulation material 540, however, will ordinarily fill the upper and lower gaps 370A, 470A. In some embodiments, the lower shell 102 includes a plurality of spaced apart lower buttress walls 510a between the lower peripheral sidewall 124 and the outermost rib of the grid structure 320. These buttress walls 510a are end portions of the corresponding lower rib 322, 324. The upper shell 104 similarly includes a plurality of spaced apart upper buttress walls 510b between the upper peripheral sidewall 134 and the outermost rib of the grid structure 420. These upper buttress walls 510b are similarly end portions of the corresponding upper rib 422, 424. FIG. 5B shows one of the lower buttress walls 510a of rib 322 between the rib 324 and the peripheral side wall 124 and one of the upper buttress walls 510b of rib 422 between the rib 424 and the peripheral side wall 134. The upper and lower buttress walls 510a,b are aligned and abut one another. However, the upper and lower buttress walls 510a,b define a channel 512 which allows the insulation material 540 to flow through the aligned upper and lower gaps 370a,b on either side of the abutting buttress walls 510a,b. Thus, the upper and lower buttress walls 510a,b have complementary profiles to form the channel 512 to facilitate the flow of insulation through the gaps at the edges of the grid structures 320, 420.

FIGS. 6A-6C depict the complementary locking structures 172 and 174 on the first side 152 and the second side 154, according to one or more embodiments. Specifically, FIG. 6B depicts the locking structure 172 and FIG. 6C depicts the corresponding locking structure 174. As previously mentioned, the locking structure 172 of the panel 100 is configured to mate and engage with the corresponding locking structure 174 of an adjacent panel 100, and the locking structure 174 of the panel 100 is configured to mate and engage with the corresponding locking structure 172 of another adjacent panel 100. In the illustrated embodiment, the locking structures 172, 174 each include an upper portion that is provided on and extends from the upper shell 104 and a lower portion that is provided on and extends from the lower shell 102, wherein the upper and lower portions are separate distinct structures that, when aligned and joined together during assembly of the panel 100, together define their respective locking structure 172, 174.

FIG. 6B shows an end view of a first corner 190a (see FIG. 1) of the panel 100, and shows what the locking structure 172 looks like from that vantage point. As shown, the locking structure 172 is configured as the female portion of the joint and the corresponding locking structure 174 of FIG. 6C is the male portion of the joint. As shown in FIG. 6B, the locking structure 172 includes a lower overhang 602 (or lower flange 602) that extends laterally outward from the lower wall 124 of the lower shell 102, and an upper overhang 604 (or lower flange 604) that extends laterally outward from the upper wall 134 upper shell 104. The lower and upper overhangs 602 and 604 are flanges that are substantially parallel to the lower wall 122 and upper wall 132 associated therewith, and the lower outer surface 112 and the upper outer surface 114 respectively extend onto the lower and upper overhangs 602 and 604. In the illustrated embodiment, the lower and upper overhangs 602 and 604 each extend laterally outward from the perimeter sidewall 140 by substantially the same distance/amount. Because the lower and upper overhangs 602 and 604 each extend outward from their respective lower wall 122 and upper wall 132, a gap 606 is defined in between the lower and upper overhangs 602 and 604.

Additionally, a lip 608 is provided on the upper overhang 604, and the lip 608 extends downward towards the lower overhang 602. A lateral side surface 616 is defined on the upper overhang 604 and the lip 608 will abut an adjacent panel. The downward extension of the lip 608 into the gap 606 forms a locking groove 610 within the gap 606, wherein the locking groove 610 is defined between the lip 608, the upper overhang 604, and the perimeter sidewall 140. As will be appreciated, the gap 606 and the locking groove 610 thereof receive the male joint portion of the locking structure 174 of an adjacent panel 100 when connecting adjacent panels together. Thus, the upper overhang 604 and the lip 608 form the upper portion of the locking structure 172 that protrudes and extends from the upper shell 104, and the lower overhang 602 forms the lower portion of the locking structure 172 that protrudes and extends from the lower shell 102.

FIG. 6C shows the shows an enhanced side view of the second corner 190b (FIG. 1) of the panel 100 to better show the, the locking structure 174 which is configured to connect to the locking structure 172. The locking structure 174 is the male portion of the joint defined by complementary locking structures 172, 174. The locking structure 174 includes a protrusion 620 that extends laterally outward from the perimeter sidewall 140 of the panel 100. The protrusion 620 is provided on both the lower shell 102 and the upper shell 104. Here, the protrusion 620 includes a lower portion 622 that is provided on and extends outwards from the lower shell 102, and the protrusion 620 includes an upper portion 624 that is provided on and extends outwards from the upper shell 104. As shown, the lower portion 622 of the protrusion 620 is formed/defined on the lower peripheral sidewall 124, and the upper portion 624 of the protrusion 620 is formed/defined on the upper peripheral sidewall 134. The lower and upper portions 622 and 624 are separate structures that are aligned and joined together during assembly of the panel 100 to thereby define the protrusion 620.

The upper portion 624 includes a lip 626 that extends upward from the upper portion 624, away from the lower portion 622. The upward extension of the lip 626 forms a locking groove 628, with the locking groove 628 being defined between the lip 626, an upper surface of the upper portion 624, and the perimeter sidewall 140. The protrusion 620 includes a lateral side surface 632 that is defined on both the lower and upper portions 622 and 624. The protrusion 620 also includes a chamfered surface 634 and a downward facing surface 636 that are both provided on the lower portion 622 of the protrusion 620.

The lip 626 and the locking groove 630 of the locking structure 174 are complementary in shape to the lip 608 and the locking groove 610 of the locking structure 172. When adjacent panels are connected together, the lip 626 of the locking structure 174 will extend upward into the locking groove 610 of the locking structure 172, and the lip 608 of the locking structure 172 will extend downward into the locking groove 630 of the complementary locking structure 174. When the locking structures 172 and 174 are joined in this manner, the protrusion 620 of the locking structure 174 will be arranged in the gap 606, with the lateral side surface 632 of the protrusion 620 abutting the surface of the perimeter sidewall 140 in the gap 606, and with the downward facing surface 636 of the protrusion 620 a top/upper surface of the lower overhang 602. In this manner, the lips 608 and 626 interlock the locking structures 172 and 174, thereby resisting separation of adjacent panels 100 until one of the panels is rotated relative to the other so as to disengage one of the lips 608, 626 from the other one of the lips 608, 626.

To connect the sides 152, 154 of adjacent panels 100, the locking structure 174 at the second side 154 of a first panel 100 is inserted into the complementary locking structure 172 at the first side 152 of the adjacent panel 100. Specifically, the first panel 100 is held at a downward angle, such that its locking structure 174 at the second side 154 is pointing downward at an angle towards the locking structure 172 at the side 152 of the other panel 100. Then, the protrusion 620 of the locking structure 174 is inserted into the gap 606 of the locking structure 172 at a sufficient angle that allows the lip 626 to be inserted into the gap 606 without being impeded by the lip 608. Once the protrusion 620 is inserted into the gap 606, the first panel 100 may be rotated downward in a direction or movement that repositions that panel 100 into a horizontal orientation, and such rotational movement will cause the lip 626 to rotate upward into the locking groove 610 behind the lip 608 of the locking structure 172. The chamfered surface 634 of the locking structure 174 facilities relative movement between adjacent panels 100 by forming a relief surface in the locking structure 174 that makes it easier to rotate that first panel 100 without any portion of the locking structure 174 contacting the adjacent panel that would otherwise resist/impede such relative movement between adjacent panels 100.

When the locking structures 172 and 174 are connected to form a joint between adjacent panels 100, the interlocking connection of the lips 608 and 626 forms a serpentine or tortuous path. This serpentine or tortuous path between the locking structures 172 and 174 inhibits the flow of fluids (that may be accidentally dropped on the panels 100) from traveling/seeping through the joint and onto the underlying ice beneath the panels 100. Moreover, by inserting the protrusion 620 within the gap 606, and with the lip 608 extending into the locking groove 628 and with the lip 626 extending into the locking groove 610, a substantial amount of material of adjacent panels 100 occupies the joint and provides thermal insulation to help maintain temperature of the underlying ice, even though the insulation material 540 of the panels 100 is not contained within the joint. Thus, the engagement of the interlocking complementary locking structures 172 and 174 helps insulate the ice underlying adjacent panels.

The locking structures 182 and 184 at the ends 162, 164 are similarly used to interlock adjacent panels 100 as detailed above. FIGS. 7A-7C depict the complementary locking structures 182 and 184 on the first end 162 and the second end 164, according to one or more embodiments. Specifically, FIG. 7A illustrates a side view of the panel, with FIG. 7B being an enhanced view of FIG. 7A to better show the locking structure 184 and FIG. 7C being an enhanced view of FIG. 7A to better show the corresponding locking structure 182. As previously mentioned, the locking structure 182 of the panel 100 is configured to mate and engage with the corresponding locking structure 184 of an adjacent panel 100, and the locking structure 184 of the panel 100 is configured to mate and engage with the corresponding locking structure 182 of another adjacent panel 100. In the illustrated embodiment, the locking structures 182, 184 each include an upper portion that is provided on and extends from the upper shell 104 and a lower portion that is provided on and extends from the lower shell 102, wherein the upper and lower portions are separate distinct structures that, when aligned and joined together during assembly of the panel 100, together define their respective locking structure 182, 184.

FIG. 7B depicts the locking structure 184 at the end 164 of the panel 100, according to embodiments. FIG. 7B also depicts an enhanced view of the injection port 150 defined in first side 152, with the pressure release port 750 formed in the second side 154 being viewable through the injection port 150. As shown, the locking structure 184 includes a lower portion 702 that extends from and is integral with the lower shell 102 and an upper portion 704 that extends from and is integral with the upper shell 104. The lower portion 702 of the locking structure 184 includes a lower extension 710 and an upwardly extending lip 712 that extends upward from the lower extension 710. The upper portion 704 of the locking structure 184 includes an upwardly extending lip 714 and an upper extension 716, wherein the upwardly extending lip 714 extends upward from the upper extension 716. As shown, the upper extension 716 is arranged on top of the lower shell 102 and abuts the upper edge of the lower shell 102 without extending beyond the lower shell 102; whereas, the lower extension 710 extends laterally outward from and beyond the upper shell 104, such that no portion of the upper shell 104 is present directly above or below the lower extension 710.

The upwardly extending lip 712 defines a lower locking groove 722, and the lower locking groove 722 is defined between the lip 712, an upper surface of the lower extension 710 and the lower peripheral sidewall 124 of the lower shell 102. The upwardly extending lip 714 defines an upper locking groove 724, and the upper locking groove 724 is defined between the lip 714, an upper surface of the upper extension 716 and the upper peripheral side wall132. As shown, the lower lip 712 protrudes laterally outward from the side of the panel 100 a greater distance/extent than does the upper lip 714, such that the lips 712, 714 and their corresponding grooves 722, 724 define a stepped structure, with the lower lip 712 and lower groove 722 extending further outward than the upper lip 714 and upper locking groove 724.

FIG. 7C depicts the locking structure 182 at the end 162 of the panel 100, according to embodiments. As shown, the locking structure 182 includes a lower portion 732 that extends from and is integral with the lower shell 102 and an upper portion 734 that extends from and is integral with the upper shell 104. The lower portion 732 of the locking structure 184 includes a lower extension 740 and a downwardly extending lip 742 that extends downward from the lower extension 740. The upper portion 734 of the locking structure 182 includes a downwardly extending lip 744 and an upper extension 746, wherein the downwardly extending lip 744 extends downward from the upper extension 746. As shown, the lower extension 740 is arranged on beneath of the upper shell 104 and abuts the lower edge of the upper shell 104 without extending beyond the upper shell 104; whereas, the upper extension 746 extends laterally outward from and beyond the lower shell 102, such that no portion of the lower shell 102 is present directly above or below the upper extension 746.

The downwardly extending lip 742 defines a lower locking groove 752, and the lower locking groove 752 is defined between the lip 742, a lower surface of the lower extension 740, and a side of the lower wall 122 of the lower shell 102. The downwardly extending lip 744 defines an upper locking groove 754, and the upper locking groove 754 is defined between the lip 744, a lower surface of the upper extension 746 and the perimeter sidewall 140 of the upper shell 104. As shown, the upper lip 744 protrudes laterally outward from the side of the panel 100 a greater distance/extent than does the lower lip 742, such that the lips 742, 744 and their corresponding grooves 752, 754 define a stepped structure, with the upper lip 744 and upper groove 754 extending further outward than the lower lip 742 and lower locking groove 752.

Because the locking structures 182, 184 are complementary with each other, and are configured to fit and mate with each other, the lower lip 742 of the locking structure 184 is spaced from the side of the lower wall 122 of the lower shell 102 the same distance that the lower lip 712 of the locking structure 184 is spaced from the perimeter sidewall 140 (i.e., from the lower peripheral sidewall 124 of the perimeter sidewall 140). In this manner, the downwardly extending lip 742 fits in the locking groove 722 and the upwardly extending lip 712 fits in the locking groove 752. Also, the downwardly extending lip 744 is spaced from the perimeter sidewall 140 the same distance as the lip 714 is spaced from the upper peripheral sidewall 134 of the upper shell 104. In this manner, the downwardly extending lip 744 fits in the locking groove 724 and the upwardly extending lip 714 fits in the upper locking groove 754. When the lips 742, 744 are received in their corresponding grooves 722, 724, and when the lips 712, 714 are received within their corresponding grooves 752, 754, the material forming the lips 712, 714, 742, 744 is in substantial and uniform contact with the material that forms the grooves 722, 724, 752, 754, so as to eliminate any void spaces or air gaps in the joint formed between locking structure 182, 184, and ensure that the joint formed between locking structure 182, 184 offers amble insulation to the ice underlying the panels even though insulation material 540 is absent from the joint area. By designing the locking structure 182, 184 such that they are in close contact with each other as shown and described, the joint between locking structure 182, 184 forms a serpentine or tortuous path that inhibits fluids from flowing there-through and onto the ice underlying the panels 100. Moreover, the interlocking structures of the locking structures 182 and 184, while not having any insulation material 540, provide a suitable amount of interlocking structure without air gaps that helps insulating the underlying ice despite being the absence of insulation material 540.

Further, because the locking structure 182, 184 are complementary shaped with opposite stepped lip configurations, the end 162 of the panel 100 at which the locking structure 182 is provided may be dropped into place on the end 164 of an adjacent panel 100 having the locking structure 184. This is because the downwardly extending lips 742, 744 of the locking structure 182 may simply fall into their corresponding grooves 722, 724 of the complementary locking structure 184.

FIGS. 8A-8D depict the corners 190a-d, respectively, of the panel 100. In particular, FIGS. 8A-8D depict how the first pair of complementary locking structures 172 and 174 and the second pair of complementary locking structures 182 and 184 are arranged at and near the corners 190a-d of the panel 100. As shown in FIG. 8A, the lip 608 of the locking structure 172 at the first side 152 does not extend fully to the first end 162, but instead stops short of the first end 162 and defines a first non-lipped portion 811 of the overhang 604. Stated differently, the lip 608 does not fully extend to the corner 190a, thereby defining the first non-lipped portion 811 of the corner 190a at the first side 152. The first non-lipped portion 811 is also shown in FIG. 7C. The lower overhang 602 extends towards the first end 162, as shown in FIG. 8A, but also stops short of the second end 164 in this embodiment. Stated differently, an end 823 of the lip 608 marks the beginning of the non-lipped portion 811, and an end 821 of the lower overhang 602 is in alignment with the end 823 of the lip 608. For example, when viewing a side view of the panel 100 from the side 152 as shown in FIGS. 7A and 7C, the ends 823 and 821 are in alignment with each other when the such that, as they both extend toward the end 162, they end at the same location on the perimeter sidewall of the panel 100. Thus, the lower overhang 602 stops/terminates at the beginning of the first non-lipped portion 811, such that the lip 608 and the lower overhang 602 each extend equal amounts towards the end 162. Here, the lower overhang 602 includes a chamfer 800 that tapers inward towards the perimeter sidewall 140 as the lower overhang 602 extends in a direction towards the end 162, with the chamfer 800 terminating at the end 821. Also, the lip 608 and the lower overhang 602 extend outward from the side 152 of the panel 100 at equal distances, such that an edge 825 of the upper wall 132 is in alignment with an edge 827 of the lower overhang 602, which is shown in FIGS. 6A-6B.

The downwardly extending lip 744 of the locking structure 182 extends downward from an edge 829 of the panel 100, but the downwardly extending lip 744 does not fully extend to the first side 152, as also shown in FIG. 8A. Stated differently, the downwardly extending lip 744 does not fully extend to the corner 190a, thereby defining a second non-lipped portion 812 of the corner at the first end 162 that starts at the end 824 of the downwardly extending lip 744. The second non-lipped portion 812 is further shown in FIGS. 6A-6B. The first corner 190a does not include a lip due to the presence of the first and second non-lipped portions 811 and 812 at the corner 190a. Instead, the first and second non-lipped portions 811, 812 defines a first corner portion 804, which is shown as a flat overhanging piece of material (of the upper wall 132 of the upper shell 104). This first corner portion 804 provides clearance/relief when adjacent panels 100 are coupled together, thereby helping to ensure that portions of adjacent panels 100 are not caught on each other when attempting to couple them together. The downwardly extending lip 742 is not aligned with the edge 829 or the lip 744, but is instead inwardly offset (toward the interior space of the panel 100) relative to the lip 744, as shown in FIGS. 7A and 7C.

With reference to FIG. 8B, the lip 608 and the lower overhang 602 of the locking structure 172 of the first side 152 are depicted at the second corner 190b. Here, the lower overhang 602 and the lip 608 both fully extend to the second corner 190b, such that there is no gap or non-lipped portion of the upper wall 132 of the upper shell 104 at the second corner 190b, as is the case with the locking structures 172 and 182 at the corner 190a. Thus, the upper wall 132 and the upper outer surface 114 thereon fully cover the lip 608 and the lower overhang 602 that underlies the lip 608. Additionally, the upward extending lips 712 and 714 of the locking structure 184 at the second end 164 extend outward from the panel 100 such that they are not covered by the upper wall 132 and the upper outer surface 114 provided thereon.

As shown in FIG. 8B, the lower overhang 602 does not fully extend to the end 164. Rather, the lower overhang 602 includes a chamfer 802, similar to the chamfer 800 at the first corner 190a, that terminates just before the second end 164 and tapers inward towards the perimeter sidewall 140. Thus, there is a second corner portion 805 of the lower peripheral sidewall 124 next to the end 164 that does not include the lower overhang 602 extending therefrom. The lack of the lower overhang 602 at the second corner portion 805 provides a clearance that facilitates installation of adjacent panels 100. Additionally, the second corner portion 805 on a first panel 100 will be overlapped by the first corner portion 804 of second panel 100 when the complementary locking structure 172 of the first panel 100 is engaged with the locking structure 174 of the second panel 100. The overlap of the first corner portion 804 over the second corner portion 805 will inhibit airflow between the adjoining panels 100.

As shown in FIG. 8A, the upper wall 132 extends further towards the end 162 than does the lower overhang 602, such that the lower overhang 602 does not fully extend to the end 162 but instead stops short thereof so that there is no portion of the lower shell 102 underlying the upper wall 132 at the corner 190a. However, a portion of the lower shell 102 (i.e., the overhang 602) does extend underneath the upper wall 132 at the second corner 190b, as shown in FIG. 8B.

As shown in FIG. 8C, downward extending lips 742 and 744 extend toward the second side 154 of the panel 100. At the third corner 190c of the panel, the downward extending lips 742 and 744 terminate with the upper wall 132, such that neither of the downward extending lips 742 and 744 extends beyond the upper wall 132 at the second side 154 (i.e., neither protrudes/extends further than the upper wall 132 at the second side 154). Stated differently, as the downward extending lips 742 and 744 extend toward the second side 154 of the panel 100, they each terminate at a location that corresponds with an edge 806 of the upper wall 132.

Referring to FIG. 8C, the lower and upper portions 622 and 624 of the protrusion 620 of the second locking structure 174 extend/protrude outward beyond the edge 806 of the upper all 132. Further, the protrusion 620 does not fully extend to the first end 162 of the panel 100, but instead the protrusion 620 stops short of the first end 162, to thereby define a third corner portion 808 of the lower and upper shells 102 and 104 at the third corner 190c that does not include the locking structure 174. Stated differently, the locking structure 174 on the second side 154 of the panel 100 does not fully extend along the second side 154, such that the locking structure 174 does not meet the locking structure 182 on the first end 162 of the panel 100, as there is the gap present in between them defined by the third corner portion 808.

Referring to FIG. 8D, the locking structure 174 at the second side 154 meets the locking structure 184 at the second end 164. Stated differently, both of the locking structures 174 and 184 extend to the fourth corner 190d. However, there is a fourth corner portion 809 at the fourth corner 190d devoid of material formed by an end surface of the locking structures 174 and 184. The fourth corner portion 809 at the fourth corner 190D of a first panel 100 will be positioned adjacent to the third corner portion 808 at the third corner 190c of a second panel 100 when the first and second panels 100 are assembled together. Additionally, FIG. 8D illustrates one of the pressure release ports 750, with the lower portion 306 thereof being defined by the lower shell 102 and the upper portion 406 thereof being defined by the upper shell 104. Further, both of the upwardly extending lips 712 and 714 extend outward beyond the edge 817 of the upper all 132.

Also disclosed herein are methods for forming or manufacturing the panel 100. The method of manufacturing the panel 100 may first include forming or manufacturing the lower shell 102 and the upper shell 104. In embodiment, this step may further include producing each of the lower shell 102 and the upper shell 104 via an injection molding process (i.e., injection molding the lower shell 102 and the upper shell 104).

The method of manufacturing the panel 100 may then include assembling or joining the lower shell 102 and the upper shell 104 together. This step may further include welding the lower shell 102 and the upper shell 104 together. In addition, this step may include aligning the lower shell 102 and the upper shell 104 together via the lower and upper alignment structures 350 and 450, and then assembling or joining the lower shell 102 and the upper shell 104 together.

Aligning the lower and upper shells 102 and 104 may include engaging the lower and upper alignment structure 350 and 450 together. In embodiments, this may include inserting a portion of the upper alignment structure 450 (e.g., the inner ring 454 thereof) into a portion of the lower alignment structure 350 (e.g., the inner ring 354 thereof), or vice versa.

The method of manufacturing the panel 100 may then include inserting or injecting the insulation material, such as the curable foam 540, into the panel 100. In particular, this step may include inserting or injecting the insulation material into the interior space defined within the panel 100 when the lower shell 102 and the upper shell 104 are assembled and joined together. This step may further include injecting the insulation material into a first plurality of interior cells of the panel 100 via a first injection port 150A, and then injecting the insulation material into a second plurality of interior cells of the panel 100 via a second injection port, and so on; and, in such embodiments, the first plurality of interior cells may be a column or row of interconnected cells extending between the first side 152 and the second side 154, and the second plurality of interior cells may be a second column or row also extending between the first side 152 and the second side 154, wherein the second plurality of interior cells is positioned on either side of the first plurality of interior cells and is closer to either the first end 162 or the second end 164 than the first plurality of interior cells. Thus, the first plurality of interior cells and the second plurality of interior cells, and any other rows of interior cells, together define a grid arrangement of interior cells within the panel 100 within which the insulation material may be injected.

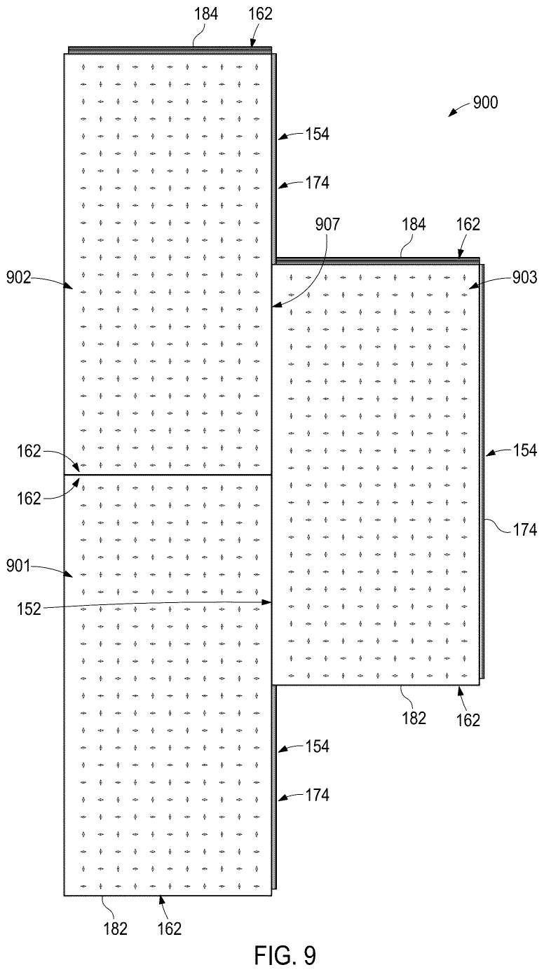

FIG. 9 illustrates a top view of a panel system 900. While the panel system 900 is shown with three panels that are each configured as described above, the panel system 900 may include more than three panels, such as any number of panels required to cover the desired area of the ice. Further, any one or more panels in the panel system 900 may be cut down so that it has a curvature that allows it to be fit in a corner region of the ice rink. As shown, the panel system 900 includes a first panel 901, a second panel 902, and a third panel 903. Each of the panels 901-903 are the panel 100 shown in FIGS. 1-8, above. As shown, the locking structure 182 at the second end 164 of the first panel 901 is mated with the locking structure 184 at the first end 162 of the second panel 902 to form a joint 905 between the first and second panels 901, 902. The complementary locking structures 182, 184 are obscured in FIG. 9. The third panel 903 is arranged to partially straddle both the first and second panels 901, 902, with the locking structure 172 (obscured in FIG. 9) on the first side 152 of the third panel 903 being mated with the locking structure 174 on the second side 154 of the both the first and second panels 901, 902 to form a joint 907 between the locking structure 172 at the first side 152 of the third panel 903 and the locking structures 174 at the second sides 154 of the first and second panels 901 and 902. Also, as shown, the third panel 903 is positioned to straddle the joint 905 between the first and second panels 901, 902. The third panel 903 covers the portion third corner 808 at the third corner 109c of the first panel 901 and the fourth corner portion 809 at the fourth corner 109d of the second panel 902.

As detailed herein, a tortuous or serpentine path is formed at the joint 905 between the first and second panels 901 and 902 due to their mating locking structures 182 and 184. Further, a tortuous or serpentine path is formed at the joint 907 between the third panel 903 and the first and second panels 901 and 902 due to the locking structure 172 of the third panel 903 mating with the locking structures 174 of the first and second panel 901 and 902. As described above, the tortuous or serpentine paths are defined by the interconnection of the lip 626 of the protrusion 620 being received within the groove 610 and the interconnection of the lip 608 within the groove 628, and the mating of the downwardly extending lips 742, 744 in the corresponding grooves 722, 724 and the mating of the upwardly extending lips 712, 714 in the corresponding grooves 752, 754. The joints 905 and 907 meet at a point 909 between the panels 901-903, and the serpentine or tortuous path is present at the point 909 to inhibit any fluids from potentially leaking through the panels 901-903 at the point 909.

Thus, each column of panels in the panel system 900 will be misaligned relative to the adjacent column as shown in FIG. 9, with the first and second panels 901, 902 being part of a first column while the third panel 903 is part of a second column adjacent to the first column. The misaligned columns of panels helps maintain the interconnection between the locking features of the panels and also helps prevent gaps being present in the panels that would allow.

Embodiments disclosed herein include:

A. A panel for protecting an ice surface comprises a lower shell and an upper shell. The lower shell comprises a lower wall and a lower peripheral sidewall extending upward from the lower wall, the lower wall and the lower peripheral sidewall together defining a lower interior cavity. The upper shell comprises an upper wall and an upper peripheral sidewall extending downward from the upper wall. The upper wall and the upper peripheral sidewall together defining an upper interior cavity. When the lower shell and the upper shell are assembled together, the lower peripheral sidewall and the upper peripheral sidewall together define a perimeter sidewall of the panel that extends between the lower wall and the upper wall, and the upper and lower interior cavities are in communication with each other such that they together form an interior space of the panel, with the interior space being defined within the lower wall, the upper wall, and the perimeter sidewall. The panel further includes complementary locking structures on opposite sides of the perimeter sidewall. The panel further includes a lower alignment structure extending upward from the lower wall and an upper alignment structure extending downward from the upper wall, the upper and lower alignment structures being complementary with each other to facilitate alignment of the upper and lower shells. The panel further includes an insulation material arranged in the interior space.

B. A method of forming a panel includes forming a lower shell and an upper shell of the panel. The lower shell comprises a lower wall and a lower peripheral sidewall extending upward from the lower wall, the lower wall and the lower peripheral sidewall together defining a lower interior cavity. The upper shell comprises an upper wall and an upper peripheral sidewall extending downward from the upper wall. The upper wall and the upper peripheral sidewall together defining an upper interior cavity. When the lower shell and the upper shell are assembled together, the lower peripheral sidewall and the upper peripheral sidewall together define a perimeter sidewall of the panel that extends between the lower wall and the upper wall, and the upper and lower interior cavities are in communication with each other such that they together form an interior space of the panel, with the interior space being defined within the lower wall, the upper wall, and the perimeter sidewall. Additionally, the panel further comprises complementary locking structures arranged on opposite sides of the perimeter sidewall; and a lower alignment structure extends upward from the lower wall and an upper alignment structure extending downward from the upper wall, the upper and lower alignment structures being complementary with each other to facilitate alignment of the upper and lower shells. The method further includes joining the lower shell and the upper shell together. The method further includes injecting an insulation material within the interior space.

Each of embodiments A and B may have one or more of the following additional elements in any combination:

Element 1: the upper and lower alignment structures contact each other and together define a structural column within the interior space of the panel when the lower shell and the upper shell are assembled together. Element 2: the upper and lower alignment structures each comprise an outer ring and an inner ring that extend from the upper and lower walls, respectively, wherein the outer rings abut each other and define a structural column within the interior space of the panel when the lower shell and the upper shell are assembled together, and wherein one of the inner rings extends within the other of the inner rings to thereby align the lower shell and the upper shell when assembled together. Element 3: the panel of claim 1, wherein the panel comprises an R-value of at least 8. Element 4: the insulation material comprises a polyurethane-based foam. Element 5: a plurality of injection ports configured to receive the insulation material formed in the perimeter sidewall in communication with the interior space of the panel when the lower shell and the upper shell are assembled together. Element 6: each injection port includes a first portion defined by the upper shell and a second portion defined by the lower shell. Element 7: a plurality of pressure release ports defined in the perimeter sidewall. Element 8: when the plurality of injection ports are defined in a first side of the perimeter sidewall and the pressure release ports are defined in a second side of the perimeter sidewall that is opposite the first side. Element 9: the lower shell comprises a lower interior grid structure and the upper shell comprise an upper interior grid structure, the lower and upper interior grid structures being joined together when the lower and upper shells are assembled to thereby define a plurality of interior cells within which the insulation material is arranged. Element 10: when the lower shell and the upper shell are assembled together, injection ports are defined in a first side of the perimeter sidewall and pressure release ports are defined in a second side of the perimeter sidewall that is opposite the first side; wherein the plurality of interior cells are arranged as a row of cells, with each row of cells having a plurality of cells extending between the first side and the second side; and wherein each of the rows of cells is associated with one of the injection ports and one of the pressure release ports. Element 11: the perimeter sidewall comprises a pair of opposing sides and a pair of opposing ends, and the complementary locking structures comprises a first pair of complementary locking structures on the pair of opposing sides and a second pair of complementary locking structures on the pair of opposing ends. Element 12: the first pair of complementary locking structures comprises a male portion on a first side of the pair of opposing sides and a female portion on a second side of the pair of opposing sides, and wherein the second pair of complementary locking structures comprises a pair of upwardly extending lips on a first end of the pair of opposing ends and a pair of downwardly extending lips on a second end of the pair of opposing ends. Element 13: the complementary locking structures each comprises a lower portion provided on and extending from the lower shell and an upper portion provided on and extending from the upper shell. Element 14: joining the lower shell and the upper shell further comprises: welding the lower shell and the upper shell together. Element 15: injecting insulation material within the interior space further comprises: injecting the insulation material through an injection port defined in the perimeter sidewall. Element 16: injecting the insulation material further comprises: injecting the insulation material through a first injection port defined in the perimeter sidewall to fill a first row of interior cells of the panel, and then injecting the insulation material through a second injection port defined in the perimeter sidewall to fill a second row of interior cells of the panel that are isolated from the first row of interior cells. Element 17: aligning the lower shell and the upper shell together prior to joining. Element 18: aligning the lower shell and the upper shell together prior to joining further comprises: inserting part of the upper alignment structure into part of the lower alignment structure.

By way of non-limiting example, exemplary combinations applicable to A and B include: Element 1 with Element 3; Element 2 with Element 3, Element 5 with Element 6, element 5 with Element 7, Element 7 with Element 8, and Element 17 with Element 18.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A panel for protecting an ice surface, comprising:
a lower shell having a lower wall and a lower peripheral sidewall extending upward from the lower wall, the lower wall and the lower peripheral sidewall together defining a lower interior cavity;
an upper shell having an upper wall and an upper peripheral sidewall extending downward from the upper wall, the upper wall and the upper peripheral sidewall together defining an upper interior cavity, wherein, when the lower shell and the upper shell are assembled together:
the lower peripheral sidewall and the upper peripheral sidewall together define a perimeter sidewall of the panel that extends between the lower wall and the upper wall, and
the upper and lower interior cavities are in communication with each other such that they together form an interior space of the panel, with the interior space being defined within the lower wall, the upper wall, and the perimeter sidewall;
complementary locking structures on opposite sides of the perimeter sidewall;
a lower alignment structure extending upward from the lower wall and an upper alignment structure extending downward from the upper wall, the upper and lower alignment structures being complementary with each other to facilitate alignment of the upper and lower shells; and
an insulation material arranged in the interior space.

2. The panel of claim 1, wherein the upper and lower alignment structures contact each other and together define a structural column within the interior space of the panel when the lower shell and the upper shell are assembled together.

3. The panel of claim 1, wherein the upper and lower alignment structures each comprise an outer ring and an inner ring that extend from the upper and lower walls, respectively, wherein the outer rings abut each other and define a structural column within the interior space of the panel when the lower shell and the upper shell are assembled together, and wherein one of the inner rings extends within the other of the inner rings to thereby align the lower shell and the upper shell when assembled together.

4. The panel of claim 1, wherein the panel comprises an R-value of at least 8.

5. The panel of claim 1, wherein the insulation material comprises a polyurethane-based foam.

6. The panel of claim 1, further comprising a plurality of injection ports configured to receive the insulation material formed in the perimeter sidewall in communication with the interior space of the panel when the lower shell and the upper shell are assembled together.

7. The panel of claim 6, wherein each injection port includes a first portion defined by the upper shell and a second portion defined by the lower shell.

8. The panel of claim 6, further comprising a plurality of pressure release ports defined in the perimeter sidewall.

9. The panel of claim 8, wherein, when the plurality of injection ports are defined in a first side of the perimeter sidewall and the pressure release ports are defined in a second side of the perimeter sidewall that is opposite the first side.

10. The panel of claim 1, wherein the lower shell comprises a lower interior grid structure and the upper shell comprise an upper interior grid structure, the lower and upper interior grid structures being joined together when the lower and upper shells are assembled to thereby define a plurality of interior cells within which the insulation material is arranged.

11. The panel of claim 10, wherein, when the lower shell and the upper shell are assembled together, injection ports are defined in a first side of the perimeter sidewall and pressure release ports are defined in a second side of the perimeter sidewall that is opposite the first side;
wherein the plurality of interior cells are arranged as a row of cells, with each row of cells having a plurality of cells extending between the first side and the second side; and
wherein each of the rows of cells is associated with one of the injection ports and one of the pressure release ports.

12. The panel of claim 1, wherein the perimeter sidewall comprises a pair of opposing sides and a pair of opposing ends, and the complementary locking structures comprises a first pair of complementary locking structures on the pair of opposing sides and a second pair of complementary locking structures on the pair of opposing ends.

13. The panel of claim 12, wherein the first pair of complementary locking structures comprises a male portion on a first side of the pair of opposing sides and a female portion on a second side of the pair of opposing sides, and wherein the second pair of complementary locking structures comprises a pair of upwardly extending lips on a first end of the pair of opposing ends and a pair of downwardly extending lips on a second end of the pair of opposing ends.

14. The panel of claim 1, wherein complementary locking structures each comprises a lower portion provided on and extending from the lower shell and an upper portion provided on and extending from the upper shell.

15. A method, comprising:
forming a lower shell and an upper shell of a panel, wherein:
the lower shell comprises a lower wall and a lower peripheral sidewall extending upward from the lower wall, the lower wall and the lower peripheral sidewall together defining a lower interior cavity;
the upper shell comprises an upper wall and an upper peripheral sidewall extending downward from the upper wall, the upper wall and the upper peripheral sidewall together defining an upper interior cavity, wherein, when the lower shell and the upper shell are assembled together:
the lower peripheral sidewall and the upper peripheral sidewall together define a perimeter sidewall of the panel that extends between the lower wall and the upper wall, and
the upper and lower interior cavities are in communication with each other such that they together form an interior space of the panel, with the interior space being defined within the lower wall, the upper wall, and the perimeter sidewall; and
the panel further comprises:
complementary locking structures arranged on opposite sides of the perimeter sidewall; and
a lower alignment structure extends upward from the lower wall and an upper alignment structure extending downward from the upper wall, the upper and lower alignment structures being complementary with each other to facilitate alignment of the upper and lower shells; and
joining the lower shell and the upper shell together; and
injecting an insulation material within the interior space.

16. The method of claim 15, wherein joining the lower shell and the upper shell further comprises:
welding the lower shell and the upper shell together.

17. The method of claim 15, wherein injecting insulation material within the interior space further comprises:
injecting the insulation material through an injection port defined in the perimeter sidewall.

18. The method of claim 15, wherein injecting the insulation material further comprises:
injecting the insulation material through a first injection port defined in the perimeter sidewall to fill a first row of interior cells of the panel, and
then injecting the insulation material through a second injection port defined in the perimeter sidewall to fill a second row of interior cells of the panel that are isolated from the first row of interior cells.

19. The method of claim 15, further comprising:
aligning the lower shell and the upper shell together prior to joining.

20. The method of claim 19, wherein aligning the lower shell and the upper shell together prior to joining further comprises:
inserting part of the upper alignment structure into part of the lower alignment structure.
